(19) United States
(12) Patent Application Publication
(10) Pub. No.: US 2005/0041418 A1
(43) Pub. Date: Feb. 24, 2005

(54) Neon light using a rope light as a light source

(76) Inventor: Ben Fan, Hsitzu City (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 10/642,827

(22) Filed: Aug. 19, 2003

(51) Int. Cl. F21S 4/00

(52) U.S. Cl. 362/217

(57) ABSTRACT

A neon light includes a cover and a rope light. The cover is composed of a milky colored U-shaped cover and a base connected to the U-shaped cover. A ledge is formed on two free sides of the U-shaped cover to correspond to two ribs formed on two upright side walls on a top face of the base. An arcuate seat is formed between the two side walls to receive thereon the rope light. Two end caps are provided to seal two open ends defined by combination between the U-shaped cover and the base.

### BACKGROUND OF THE INVENTION

1. Field of the Invention

The present invention relates to a neon light, and more particularly to a neon light having therein a rope light as a light source to emit light such that the waterproof capability of the neon light is improved.

2. Description of Related Art

With reference FIG. 6, a conventional neon light has a transparent or translucent tube (1), a supporting bracket (2) having the tube (1) thereon, a circuit board (3) received in the tube (1) and two end caps (4) to end cap two open ends of the tube (1) to prevent water from seeping into the tube (1) to damage the circuit board (3). The circuit board (3) has multiple light emitting diodes (31) (LED) mounted thereon so that when the LED (301) are lit, the light from the LED (301) is able to pass through the transparent or translucent tube (1) to emanate a soft light. Because the material for the tube (1) is milky colored and the LED (301) can be arranged to emit different colors, a colorful and soft visual effect is thus created, which is very similar to a real neon light. However, because the connection between the tube (1) and the supporting bracket (2), the end caps (4) and the tube (1) and the circuit board (3) and the tube (1) arc glued together, waterproof capability of the conventional neon light is poor and the circuit board (3) is very possible to be damaged by the seeping moisture. What is more important is that after they are glued together, the assembly of the device becomes quite inconvenient. U.S. Pat. No. 6,557,282; 6,158,882; 6,283,612 are patents discussing different neon lights which are similar to the one described above. That is, they all have the same problem of high production and maintenance fee.

In U.S. Pat. No. 6,361,186, the LEDs are placed inside an opaque chamber. A transparent tube is placed in front of the LEDs such that the light from the LEDs is able to be scattered, refracted and reflected by the transparent tube. The transparent tube is easily disassembled for repair so that the maintenance fee is reduced. However, due to the consideration of easy assembly of the transparent tube, the waterproof capability is thus sacrificed. Furthermore, the application of the circuit board increases the manufacture cost.

To overcome the shortcomings, the present invention tends to provide an improved neon light to mitigate the aforementioned problems.

### SUMMARY OF THE INVENTION

The primary objective of the present invention is to provide an improved neon light to greatly reduce the maintenance fee and increase the waterproof capability of the neon light.

Another objective of the present invention is that a rope light is received in a milky colored U-shaped cover so that the light from the rope light after passing through the milky colored U-shaped cover is soft.

Still another objective of the present invention is that the base for connecting to the milky colored U-shaped cover is opaque. Therefore, the light from the LEDs is able to be totally reflected, refracted or scattered through the milky colored U-shaped cover.

A further objective of the present invention is that the rope light has a milky colored gel injection molded outside each one of the LEDs so that the waterproof capability of the neon light of the present invention is high.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the neon light of the present invention;

FIG. 2 is a perspective view of the neon light in FIG. 1 in assembly;

FIG. 3 is a schematic view showing the structure of the rope light used in the neon light of the present invention;

FIG. 4 is an exploded perspective view of the converter in the rope light in FIG. 3;

FIG. 5 is a schematic perspective view showing the inner structure of the rope light; and

FIG. 6 is an exploded perspective view of a conventional neon light.

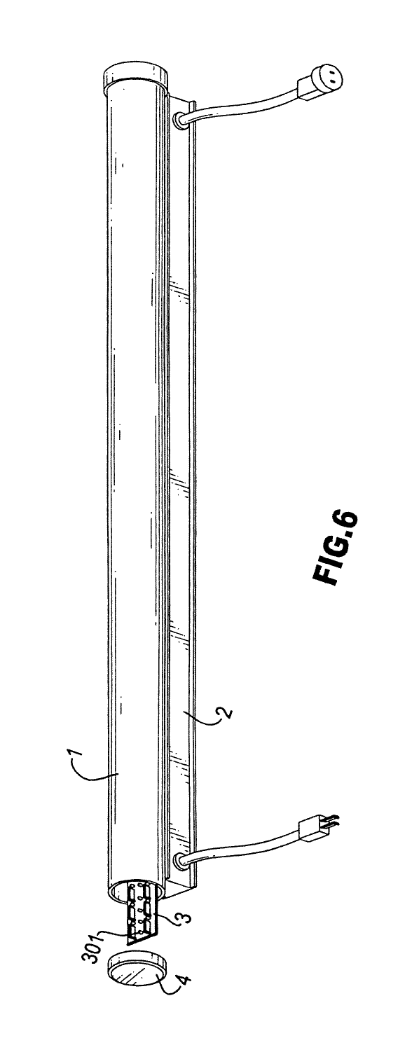

### DETAILED DESCRIPTION OF THE PREFERRED EMBODIMENT

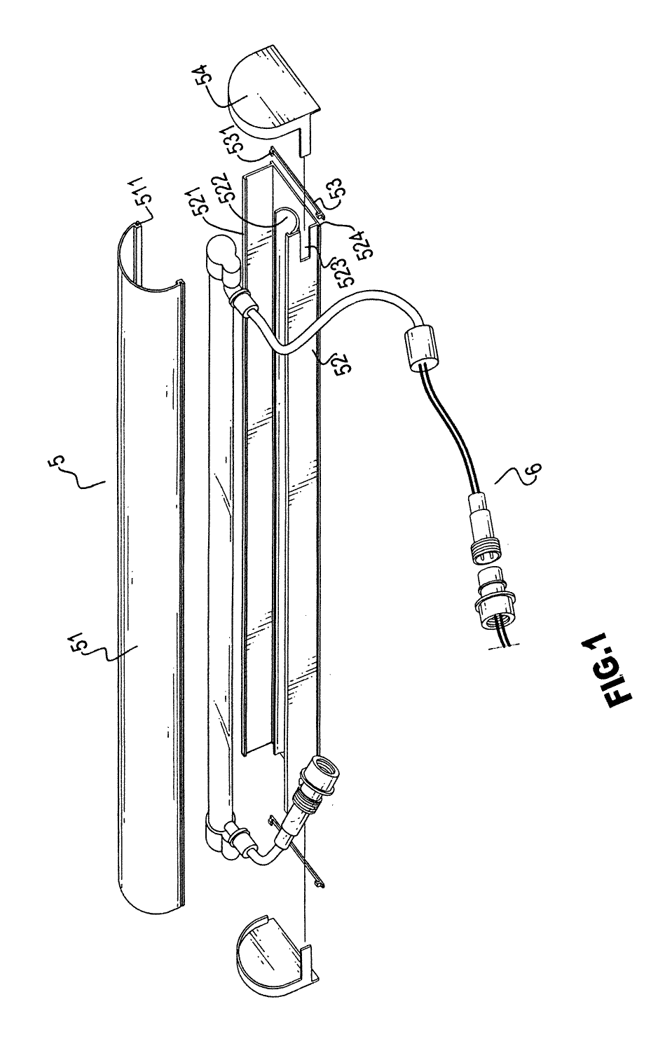

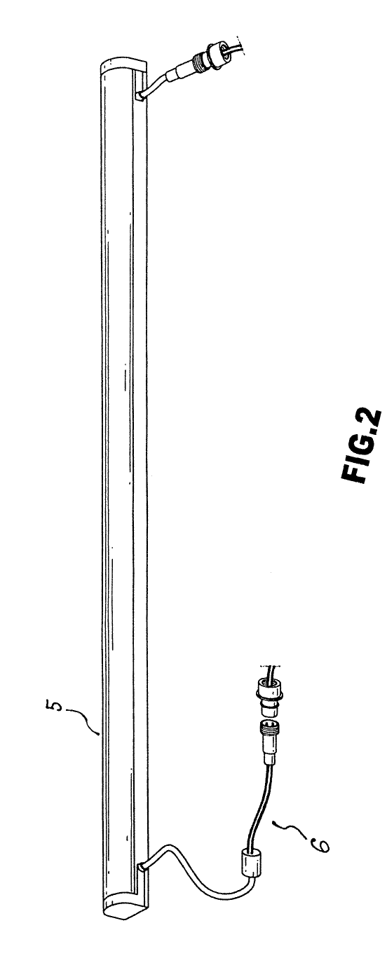

With reference to FIGS. 1 and 2, the neon light in accordance with the present invention includes a cover (5) and a rope light (6).

The cover (5) is composed of a translucent U-shaped cover (51) and a base (52) corresponding and connected to a bottom of the U-shaped cover (51). A ledge (511) is formed on two longitudinal sides of the U-shaped cover (51). A rib (521) is formed on two longitudinal free sides of the two side wails of the base (52) to correspond to the ledge (511). The two side walls (not numbered) are respectively perpendicularly extended from a bottom face of the base (52) and an arcuate seat (522) is longitudinally formed between the two side walls of the base (52). One of the two side walls has two cutouts (523) oppositely defined in two distal ends of the side wall. A recess (524) is formed on a joint of each of the two side walls and the bottom face of the base (52) to correspond to a positioning element (53). The positioning element (53) has two extensions (531) extending outward to correspond to the two recesses (524) of the base (52).

An end cap (54) is provided to seal two open ends of the cover (5) after the U-shaped cover (51) and the base (52) are assembled.

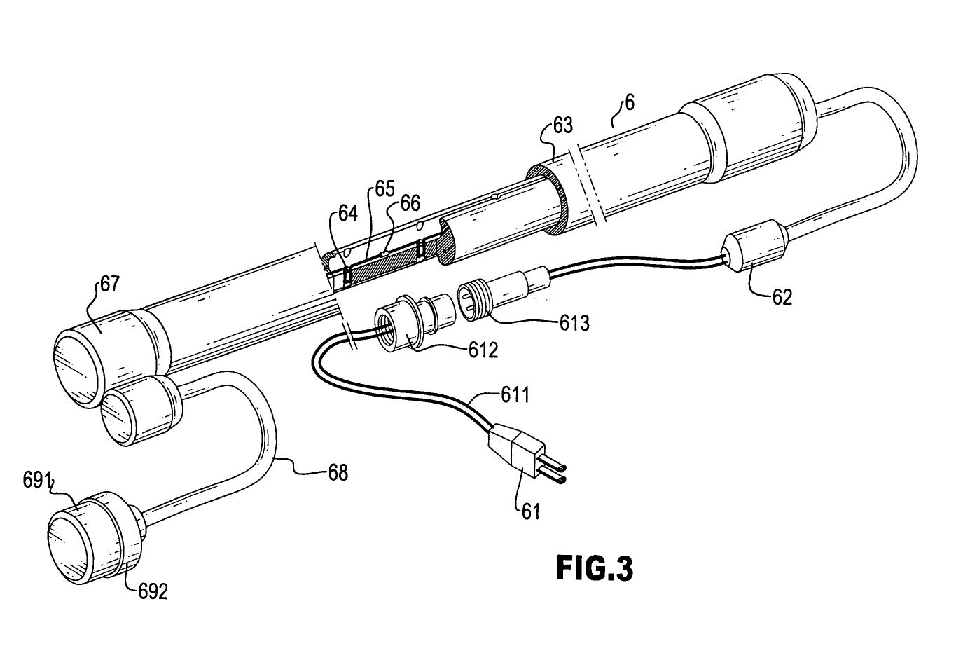

With reference to FIG. 3, the rope light (6) of the present invention has a plug (61) with a power cord (611). A fast-release male connector (612) is formed on the power cord (611) opposite to the plug (61). A fast-release female connector (613) is provided to connect to the fast-release male connector (612) and electrically connected to a converter (62) which is to convert alternate current to direct current (AC-DC). The rope light (6) is provided with a milky colored gel body (63) injection molded to enclose therein light emitting diodes (64), wires (65) and resistor (66). At a distal end opposite to the plug (61), an end cap (67) is injection molded at the distal end of the milky colored gel body (63). A secondary cord (68) may be provided to electrically connect to the power cord (611) and has a female connector (691) connected to a male connector (692) which is formed on a distal end of the secondary cord (68) such that the user may unscrew the female connector (691) for extension with another fast-release male or female connector depending on the requirements.

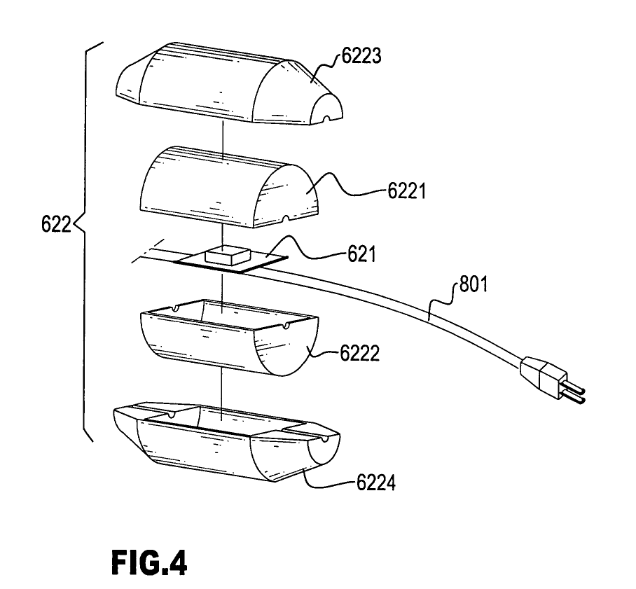

With reference to FIG. 4, the converter (62) in FIG. 3 includes a circuit board (621) and a casing (622) which is composed of an inner upper cap (6221), an inner lower cap (6222), an outer upper cap (6223) and an outer lower cap (6224). The circuit board (621) is electrically connected to the power cord (611). Then the inner upper cap (6221) and the inner lower cap (6222) are connected to each other to enclose therein the circuit board (621). Thereafter, the outer upper cap (6223) and the outer lower cap (6224) are formed outside the inner upper cap (6221) and the inner lower cap (6222) by injection molding so that the converter (62) is completely waterproof.

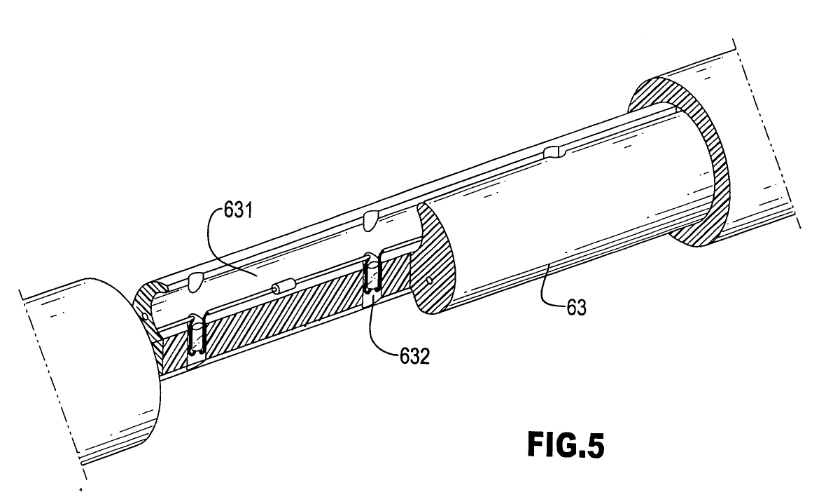

With reference to FIG. 5, it is noted that the milky colored gel body (63) is defined therein with a longitudinal channel (631). Multiple radially defined notches (632) are defined in the milky colored gel body (63) to respectively communicate with the longitudinal channel (631). With such an arrangement of the longitudinal channel (631) and the notches (632), the LEDs (64) are respectively received in a corresponding one of the notches (632) and the wires (65) and the resistors (66) are received in the longitudinal channel (631). Thus, the rope light of the present invention is resilient for folding and bending without damaging the electrical connection between the LEDs (64), the wires (65) and the resistors (66).

With reference to FIGS. 1 and 2, when the neon light of the present invention is in assembly, the rope light is first received in a space defined by the base (52) and the U-shaped cover (51), wherein the ledges (511) are connected to the ribs (521) to secure engagement between the U-shaped cover (51) and the base (52). Thereafter, the power cord (611) may extend out of the cover (5) from one of the cutouts (523) and the secondary cord (68) may extend out of the cover from the other cutout (523). Then the positioning element (53) is connected to the base (52) by inserting two extensions (531) which are formed on the positioning element (53) into the two recesses (524) in the base (52) and the end caps (54) are applied to seal the two open ends of the cover (5) to enclose therein the rope light (6). Thereafter, the assembly of the neon light of the present invention is completed.

It is noted that to further enhance the emission of the light from the LEDs (64), it is recommended to place an opaque metal plate on a bottom face of the arcuate seat (522) so that the light from the LEDs (64) can only emanate from the U-shaped cover (51).

In conclusion, the neon light of the present invention is entirely waterproof due to the injection molding of the milky colored gel body outside the LEDs (64), the wires (65) and the resistors (66). Therefore, even the neon light is applied in rainy days or in an environment with high humidity, the circuitry of the rope light may still remain intact. Furthermore, because the assembly of the present invention is easy, the manufacture cost is low.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A neon light comprising:
a base with two upright extending side walls longitudinally formed on a top face of the base and an arcuate seat longitudinally formed between the two side walls, wherein one of the two side walls has a cutout defined in two opposite ends;
a milky colored U-shaped cover mounted on top of the base to secure engagement with the base;
two end caps respectively applied to seal two open ends of a combination between the base and the U-shaped cover; and
a rope light securely rested on top of the arcuate seat and extending out of the combination of the base and the U-shaped cover, wherein the rope light has a plug formed on a first distal end of a power cord, a fast-release male connector formed on a second distal end of the power cord, a fast-release female connector formed on a first distal end of a milky colored gel body to correspond to the fast-release male connector, wires received in a longitudinal channel inside the milky colored gel body to electrically connect light emitting diodes received in notches radially defined in the milky colored gel body to respectively communicate with the longitudinal channel, resistors received in the longitudinal channel and connected to the light emitting diodes by the wires and a converter electrically connected to the power cord by the wires and connection between the fast-release male connector and the fast-release female connector,
whereby the power cord and the secondary cord may extend out of the base from the cutouts in one of the two side walls.

2. The neon light as claimed in claim 1, wherein an end cap is formed on a second distal end of the rope light and opposite to the end cap.

3. The neon light as claimed in claim 2 further comprising a secondary cord electrically connected to the power cord for connection to another rope light, wherein a free end of the secondary cord is provided with a male connector and a female connector which is threadingly connected to the male connector so that the female connector is able to be removed for connection with another rope light.

4. The neon light as claimed in claim 1, wherein a ledge is longitudinally formed on two distal sides of the U-shaped cover and a rib is longitudinally formed on two free ends of the two side walls to correspond to the ledges such that the U-shaped cover is able to connect to the base.

5. The neon light as claimed in claim 2, wherein a ledge is longitudinally formed on two distal sides of the U-shaped cover and a rib is longitudinally formed on two free ends of the two side walls to correspond to the ledges such that the U-shaped cover is able to connect to the base.

6. The neon light as claimed in claim 3, wherein a ledge is longitudinally formed on two distal sides of the U-shaped cover and a rib is longitudinally formed on two free ends of the two side walls to correspond to the ledges such that the U-shaped cover is able to connect to the base.
